(19) United States
(12) Patent Application Publication
(10) Pub. No.: US 2004/0198374 A1
(43) Pub. Date: Oct. 7, 2004

(54) Location control and configuration system

(76) Inventor: Sundeep M. Bajikar, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/185,873

(22) Filed: Jun. 27, 2002

(51) Int. Cl. H04Q 7/20

(52) U.S. Cl. 455/456.1

(57) ABSTRACT

The present disclosure relates to configuring the operation of a device based upon a selected location mode, and more specifically configuring the operation of the device based on a location mode selected by a graphical control element.

### BACKGROUND

1. Field

The present disclosure relates to configuring the operation of a device based upon a selected location mode, and more specifically configuring the operation of the device based on a location mode selected by a graphical control element.

2. Background Information

Computer systems are becoming increasingly pervasive in our society, including everything from small handheld electronic devices, such as personal data assistants and cellular phones, to application-specific electronic devices, such as set-top boxes, digital cameras, and other consumer electronics, to medium sized mobile systems such as notebook sub-notebook, and tablet computers, to desktop systems, workstations, and servers. Currently, a computer, or similar device, typically executes instructions without regard to its physical location. As a result, when an application requests a location, a user needs to manually enter the location of the device. For example, if a user wishes to find a local movie theater using a web site, the web site may typically request that the user supply a location to the web site. The user often manually supplies this information to the web site.

In another example, if a user wishes to print to the nearest printer, the user often determines the printer that is physically closest to the user's computer; the user determines the network identifier for that printer; and configures their computer to print to that printer. This is often cumbersome and may require the user to supply information that is not readily available, such as, for example a zip code or the network address of another device.

There are currently techniques that may be used by the user to statically configure a device with location information. Some of these techniques currently require that the location information, once configured, always be used. For example, the movie theater web site above may assume that a user is at the location the user entered the first time the user used the site. Even if the user wishes to retain their privacy regarding their location, the previously entered location will often be transmitted to the web site.

In another example, if a user configured their computer to use a printer close to the user's office in the state of New York, the computer will typically continue to attempt to print to the printer in New York, even if the user is on a trip to California. In order to reset the printer configuration, the user may need to manually change the preferred printer settings every time the user wishes to print, or the user may need to go through a cumbersome series of dialog boxes to semi-permanently reconfigure the computer's printing preferences.

An embodiment of the disclosed mater may address one or more problems associated with the prior art.

### BRIEF DESCRIPTION OF THE DRAWINGS

Subject matter is particularly pointed out and distinctly claimed in the concluding portions of the specification. The disclosed matter, however, both as to organization and the method of operation, together with objects, features and advantages thereof, may be best understood by a reference to the following detailed description when read with the accompanying drawings in which:

FIG. 1 is a block diagram illustrating a device that allows for dynamic configuration utilizing a location control system;

FIG. 2 is a flow chart illustrating a technique for dynamically configuring a device utilizing a location control system.

### DETAILED DESCRIPTION

In the following detailed description, numerous details are set forth in order to provide a thorough understanding of the present disclosed matter. However, it will be understood by those skilled in the art that the claimed subject matter may be practiced without these specific details. In other instances, well-known methods, procedures, components, and circuits have not been described in detail so as to not obscure the disclosed matter.

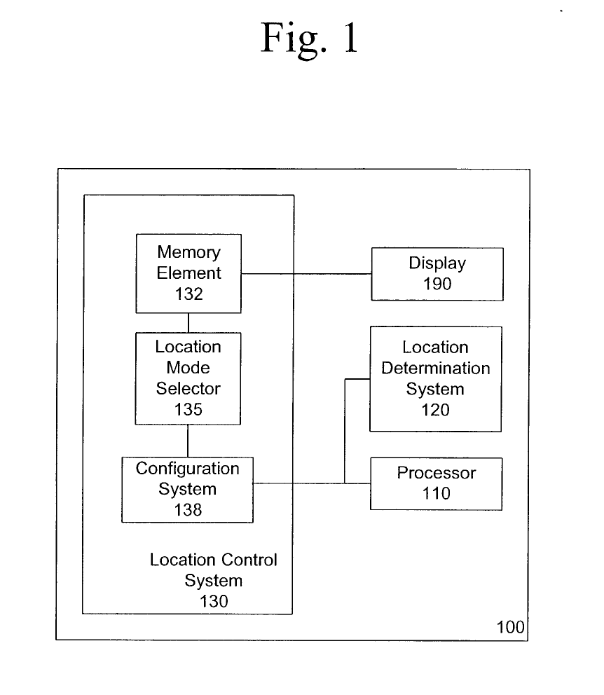

FIG. 1 is a block diagram illustrating an embodiment of the disclosed matter. A device 100 that embodies the disclosed matter may include a location determination system 120, and a location control system 130. A system that embodies the disclosed matter may include the components of device and a processor 110 and display 190. In one specific example, a user may have a personal digital assistant (PDA) that includes a location determination system 120, and a location control system 130. In this specific example, a user may want to receive information that is relevant, given the PDA's physical location. It is contemplated that device 100 may be a device, such as, for example, a personal computer, a laptop, a cellular telephone, or a device mounted with a vehicle (e.g. a navigation system mounted within an automobile's dashboard). However, these are merely a few non-limiting examples.

Location determination system 120 may determine the physical location of the device or a component of the device. In the specific example above, the PDA may be part of a wireless network that utilizes a protocol that is substantially in compliance with, for example, the IEEE 802.11b wireless local area network (WLAN) standard. Supplement to 802.11-1999, Wireless LAN MAC and PHY specifications: Higher speed Physical Layer (PHY) extension in the 2.4 GHz band, IEEE Std. 802.11b-1999 (hereafter “802.11b”). In another embodiment of this specific example, the PDA may utilize a protocol, which is substantially in compliance with, for example, any standard derived from or supplemental to the IEEE 802.11 wireless local area network (WLAN) standard (hereafter, “the 802.11 standard or specification family”). Standards for Information Technology—Telecommunications and Information Exchange between Systems—Local and Metropolitan Area Network—Specific Requirements—Part 11: Wireless LAN Medium Access Control (MAC) and Physical Layer (PHY) Specifications, ANSI/IEEE Std. 802.11-1999 (hereafter “802.11”). Of course, it is contemplated that another embodiment of the disclosed matter may utilize any other wireless protocol, or a wired protocol.

In this specific example, the location determination system 120 may determine the physical location of the device by measuring the distance between the PDA and another device that is transmitting a signal via the wireless network. By repeating this estimation process, the location of the device may be determined. It is contemplated that the location determination system 120 may also estimate the physical location of the device by utilizing other techniques, such as, for example, a global positioning system (GPS), a preconfigured setting, or a signal from another device. Such a signal from another device may contain information that represents the location of the transmitting device, a port used to connect the receiving device to a network, or another device on the network. These are merely a few non-limiting examples of techniques that may be used by the location determination system 120 to estimate the physical location of the device.

Location determination system 120 may be coupled to location control system 130. Location determination system 120 may transmit, to location control system 130, a signal that contains information representing the determined location of the device. Location control system 130 may configure the device to operate in a certain selected location mode. Each location mode may be associated with certain location information, such as, for example, an address or geographical coordinate, and also associated with instructions or rules that cause processor 110 to execute a certain set of instructions, or execute instructions in a certain manner. For example, in a first location mode, the device may transmit the location determined by the location determination system 120 to any requesting device. In a second location mode, the device may operate as if the location determination system 120 did not exist. Essentially, when operating in a second location mode the device would operate without regard to any location information. It is contemplated that other examples of location modes may be used, such as, for example, using a preconfigured location, or using a modified version of the location supplied by the location determination system 120. Alternatively, different location modes may use the same location information but configure the processor to execute different sets of instructions. Of course, these are merely a few non-limiting examples.

Another example of the instructions or rules that may dictate the usage of the location associated with a location mode may include altering the associated location prior to the location's utilization, possibly during specific circumstances. For example, a user may wish to retain a degree of privacy, and the location mode may reduce the accuracy of the associated location by a degree of magnitude, for example. In a specific example, if the location is represented as a mailing address (a street number, city, state, and zip code.), reducing the accuracy of the location by an order of magnitude may involve reducing the location to represent the address as a city, state and zip code, but not a street number. In another example of altering the location may include setting the location for the location mode to an alternate value. For example, one location mode may dictate that when a certain application requests the location information a predetermined location is used. Specifically, a location mode may dictate that the DVD player report that the user is within Europe regardless of the user's actual physical location, such as, for example, the United States or China. Yet another example of altering the location associated with a location mode may include enhancing the location using preconfigured information. For example, a location may be associated with a sales tax rate based upon a database containing the proper tax rates for a location and the location information associated with the location mode. It is contemplated that other techniques may be used to alter the location associated with a particular location mode.

Yet another example of the instructions or rules that may dictate the usage of the location associated with a location mode may include allowing utilization of the associated location during specific circumstances. For example, a user may wish to disallow the utilization of the location information outside of the device or the transmission of the information over a network. In a specific example, a user may select a location mode that disallows transmission of the location information over the Internet via a web browser. In another example, the utilization of the location information may be allowed if the information is transmitted to a trusted destination. In the specific example above, the location might be transmitted to an approved bank web site.

In another example, the utilization of the location information may be allowed or disallowed by a specified user-level application. In a specific example, a location mode may allow access to the location information by an email client but not a web browser. In yet another example, the location information may be used to configure an operating system level or user level application. In this context, a user level application may be a program often used by an end user to perform a specific task, such as, for example, Microsoft Office, Adobe Photoshop. In this context, an operating system level application may be a program, daemon, or service that is typically automatically run by a computer and may be used by a user level application. An example of an operating system level application may include a program that manages memory, files, date and time, a network interface or a firewall. Of course, these are merely a few non-limiting examples. In a specific example, the location information may be used to configure a network interface to use a certain network address or alter the time settings of the computer to represent the time zone of the location. In an example involving a user-level application, a spreadsheet program may be configured to use a certain interest rate or currency associated with the location. It is contemplated that other examples and embodiments may involve other techniques for allowing the utilization of the location information under specific circumstances.

Another example of instructions or rules that may dictate the usage of the location associated with a location mode may include blocking the utilization of the location information. In addition to all the above examples, access or usage of the location information may be blocked for a specific application. A specific example may include blocking a media-playing program from reading the location information. An alternative example may include requesting the user to confirm that the location information may be accessed or transmitted over a network before the action is performed. These are merely a few non-limiting examples and other examples may be used. It is further contemplated that configuration system 138 may configure applications or the device to accommodate any of the above examples or other possible embodiments of the location modes.

Location control system 130 may contain a component to show a graphical control element on a display 190. Such a display 190 may be part of the device or a separate device that may be combined with device 110 to create a system. In the specific example above, a display control component may show a button that is part of a toolbar. The toolbar may be associated with an application, such as, for example, a web browser. It is contemplated that a graphical element could be associated with other applications, such as, for example, an email client, a video or teleconferencing application, an application that uses maps, or a specialized application that is used by sales agents. However, these are merely a few non-limiting examples. In the specific example above, display control component may be a set of instructions that, for example, show a location button on the toolbar of a web browser. It is further contemplated that display control component may be implemented in software, firmware, hardware or a mixture thereof. It is contemplated that this control element could alternately be implemented as a physical switch or other physical element.

Location control system 130 may also contain location mode selector 135 to select the active location mode of the device. As described above, a location mode may cause the device to utilize a location from a particular source, or utilize a location in a certain manner. It is contemplated that location mode selector 135 may, for example, select between two location modes, cycle among a plurality of location modes, or select one location mode from a group of location modes. Of course, these are merely a few non-limiting examples. In the specific example above, a user may select the button on the web browser's toolbar, and location mode selector 135 may then change the selected location mode to a mode that allows the location information determined by location determination system 120 to be transmitted to another device. In the specific example above, location mode selector 135 may be a set of instructions that, for example, detect when the button is selected and changes the selected location mode accordingly. It is further contemplated that location mode selector 135 may be implemented in software, firmware, hardware or a mixture thereof.

Location control system 130 may further contain configuration system 138 to configure the device to process a certain set of instructions, or to configure the device to process instructions in a certain manner. In the specific example, after the user has selected the location mode, configuration system 138 may cause instructions to be executed by the processor so that the location determined the location determination system 120 is transmitted to any requesting web site. Using this location information, a web site may transmit information to the device that is relevant to the location of the device. For example, weather, news, events, traffic or entertainment information may types of information that is filtered based upon the location of the device. Alternatively, the web site may transmit unfiltered information to the device, and the device may filter the information based on the selected location mode.

In other examples, configuration system 138 may configure the device to use a certain device or devices on a network, a certain network connection, a certain level of network security or privacy. In another specific example, configuration system 138 may configure the device to print to the nearest printer. Configuration system 138 may change the firewall settings of the device based upon whether the device is located within a company's office building or not. Another example may be supplying an e-commerce with the location of user in order to determine the proper tax to charge the user. Alternatively, the device may be configured to ask the user before any location information is transmitted to another device. Of course, these are merely a few non-limiting examples and other configurations and sets of instructions are contemplated. In the specific example above, configuration system 138 may be a set of instructions that when executed cause the processor to process a certain set of instructions. It is contemplated that the new configuration effected by configuration system 138 may take effect after the device completes a power cycle, a software reset, a restart of an application, after a fixed amount of time or immediately. It is further contemplated that configuration system 138 may be implemented in software, firmware, hardware or a mixture thereof.

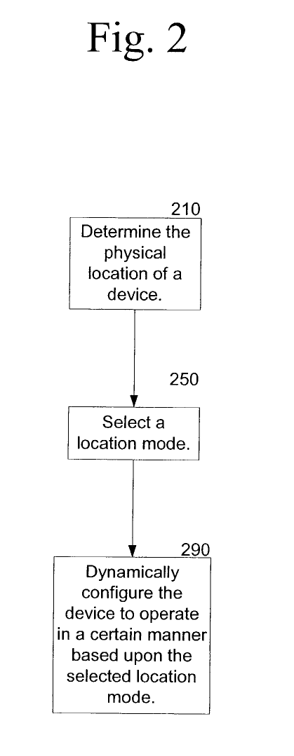

FIG. 2 illustrates a technique of the disclosed matter. Action 210 illustrates that the physical location of a device may be determined. It is contemplated that the physical location of the device need not be determined with absolute accuracy. Depending upon what the information of the physical location will be used for, differing degrees of accuracy may be desired. For example, if the determined location is used to compute a zip code, the determination may be sufficiently be accurate within a mile or less. Conversely, if the determined location is used to configure a device to print to the nearest printer, the determination may need to be accurate to a meter. However, these are merely two non-limiting examples.

Action 250 illustrates selecting a location mode by activating a control element. In a specific example, the user of a laptop may have a toolbar associated with a web browser. This toolbar may contain a button (control element) that allows the user to toggle between a location mode that allows the determined location of the device to be considered when executing instructions, and a location mode that does not allow the determined location to be considered when executing instructions. The user may select between these two example location modes by selecting the toolbar button. It is contemplated that other control elements may be used, and this is merely one specific illustrative example.

Action 250 may include actions to draw or show a graphical control element, such as, for example the toolbar button, on a display. Action 250 may also include actions to select a location mode from among a set of possible location modes. Action 250 may even include actions to store this selected location mode to a device.

Action 290 illustrates that a device may be dynamically configured to operate in a certain manner based upon the selected location mode. In one example, action 290 may result in the execution of a first set of instructions if a first location mode is selected, and that result in the execution of a second set of instructions if another location mode is selected. In the specific example above, the laptop's user may select the toolbar button and enable a location mode that uses the determined location information. Upon the selection of this particular location mode, the laptop may be configured to use certain network settings (proxy server, web site mirrors, etc.). When the user deselects this location mode, the laptop may be configured to use other network settings, such as, for example, no proxy server, or different web sire mirrors. It is contemplated that other configurations may be used and that the above is merely one non-limiting illustrative example.

While certain features of the disclosed subject matter have been illustrated and described herein, many modifications, substitutions, changes, and equivalents will now be evident to those skilled in the art. It is, therefore, to be understood that the appended claims are intended to cover all such modifications, substitutions, changes, and equivalents and changes that fall within the broader spirit of the disclosed subject matter.

1. An article comprising:
a storage medium including a first plurality of machine accessible instructions, that when executed by a system, cause the system to perform a method comprising determining the physical location of a component;
selecting a location mode from a plurality of location modes;
configuring a second plurality of machine accessible instructions based upon the location mode.

2. The article of claim 1, wherein the location mode includes
a location information and
a instructions involving the utilization of the location information.

3. The article of claim 2, wherein the instructions involving the utilization of the location information includes at least one set of instructions from the following:
altering the location information prior to utilization;
allowing utilization of the location information under specific circumstances; and
blocking utilization of the location information.

4. The article of claim 3, wherein altering the location information prior to utilization includes at least one of the following:
reducing the accuracy of the location information by an order of magnitude;
setting the location information to an alternate value;
enhancing the location information utilizing a set of preconfigured information; and
reducing the accuracy of the location information under specific circumstances.

5. The article of claim 3, wherein allowing utilization of the location information under specific circumstances includes at least one of the following:
disallowing the utilization of the location information outside the system;
disallowing the transmission of the location information via a network;
allowing the transmission of the location information via a network to a trusted destination;
allowing the location information to be accessed by user level machine accessible instructions;
allowing the utilization of the location information to configure operating system level machine accessible instructions; and
allowing the utilization of the location information to configure user level machine accessible instructions.

6. The article of claim 3, wherein blocking utilization of the location information includes at least one of the following:
blocking the utilization of the location information outside the system;
returning an alternate location information in response to a request for the location information;
requesting user confirmation before the location information is transmitted via a network;
requesting user confirmation before the location information is accessed by a set of machine accessible instructions; and
blocking the utilization of the location information by a specified set of machine accessible instructions.

7. The article of claim 3, wherein configuring a second plurality of machine accessible instructions based upon the location mode includes at least one of the following:
configuring a plurality of machine accessible instructions that affect a network interface;
configuring a plurality of machine accessible instructions that affect a localization setting;
configuring a plurality of machine accessible instructions that affect a digital rights management scheme; and
configuring a plurality of machine accessible instructions to dynamically provide the location information when requested by a third plurality of machine accessible instructions.

8. The article of claim 7, wherein selecting a location mode including activating a control element.

9. The article of claim 8, wherein the control element is a physical switch coupled with the system.

10. The article of claim 8, wherein the control element is associated with a plurality of instructions that comprise at least one of the following:
a web browser;
an email client;
a map generation application;
a conferencing application; and
a specialized application used by a sales agent.

11. The article of claim 7, wherein configuring a second plurality of machine accessible instructions based upon the location mode includes configuring the second plurality of machine accessible instructions such that the configuration is immediately utilized.

12. The article of claim 2, wherein the location information includes one of the following:
the determined physical location of a component;
a preconfigured physical location;
an invalid value for the physical location; and
an altered version of the determined physical location of a component.

13. An apparatus comprising:
a location determination system to determine the location of the apparatus;
a location control system to configure the apparatus depending on the location and a location mode.

14. The apparatus of claim 13 wherein the location control system includes:
a memory element to store a location information;
a location mode selector to select a location mode; and
a configuration system to configure the apparatus based at least in part upon the selected location mode.

15. The apparatus of claim 14 wherein the location mode includes:
a location information; and
a configuration setting to facilitate the configuration of the apparatus utilizing the location information.

16. The apparatus of claim 15 wherein the configuration setting includes at least one of the following:
a setting to alter the location information prior to utilization;
a setting to allow utilization of the location information under specific circumstances; and
a setting to block utilization of the location information.

17. The apparatus of claim 16 wherein the configuration setting to alter the location information prior to utilization includes at least one of the following:
a setting to reduce the accuracy of the location information by an order of magnitude;
a setting to change the location information to an alternate value;
a setting to enhance the location information; and
a setting to reduce the accuracy of the location information under specific circumstances.

18. The apparatus of claim 17 wherein the setting to allow the utilization of the location information under specific circumstances includes at least one of the following:
a setting to disallow utilization of the location information externally to the apparatus;
a setting to disallow the transmission of the location information via a network;
a setting to allow the transmission of the location information via a network to a trusted destination;
a setting to allow the location information to be accessed by user level machine accessible instructions;
a setting to allow the utilization of the location information to configure operating system level machine accessible instructions; and
a setting to allow the utilization of the location information to configure user level machine accessible instructions.

19. The apparatus of claim 16 wherein the setting to block the accuracy of the location information includes at least one of the following:
a setting to block the utilization of the location information externally to the apparatus;
a setting to return an alternative location information in response to a request for the location information;
a setting to request confirmation before the location information is transmitted via a network;
a setting to request confirmation before the location information is accessed by a set of machine accessible instructions; and
a setting to block the utilization of the location information by a specified set of machine accessible instructions.

20. The apparatus of claim 14 wherein the configuring system configures the apparatus to facilitate the use of the location mode via at least one of the following:
the utilization of a network interface;
the formatting of data based upon localization settings;
the utilization of a digital rights management scheme; and
the ability of a set of machine accessible instructions to access the location information.

21. The apparatus of claim 15 wherein the location information includes at least one of the following:
the determined physical location of the apparatus;
a preconfigured physical location;
an invalid value for the physical locations; and
an altered version of the determined physical location of the apparatus.

22. The apparatus of claim 15 wherein the location mode selector includes a control element that is associated with a set of machine accessible instructions that comprises at least one of the following:
a web browser;
an email client;
a map generation application;
a conferencing application; and
a specialized application used by a sales agent.

23. A system comprising:
a processor to process machine accessible instructions;
a video display that is at least partially affected by machine accessible instructions processed by the processor;
a location determination system to determine the location of the system;
a location control system to configure the system depending on the location and a location mode.

24. The system of claim 23 wherein the location control system includes:
a memory element to store a location information;
a location mode selector to select a location mode; and
a configuration system to configure the system based at least in part upon the selected location mode.

25. The system of claim 24 wherein the location mode includes:
a location information; and
a configuration setting to facilitate the configuration of the system utilizing the location information.

26. The system of claim 25 wherein the configuration setting includes at least one of the following:
a setting to alter the location information prior to utilization;
a setting to allow utilization of the location information under specific circumstances; and
a setting to block utilization of the location information.

27. The system of claim 26 wherein the configuration setting to alter the location information prior to utilization includes at least one of the following:
a setting to reduce the accuracy of the location information by an order of magnitude;
a setting to change the location information to an alternate value;
a setting to enhance the location information; and
a setting to reduce the accuracy of the location information under specific circumstances.

28. The system of claim 27 wherein the setting to allow the utilization of the location information under specific circumstances includes at least one of the following:
a setting to disallow utilization of the location information externally to the system;
a setting to disallow the transmission of the location information via a network;
a setting to allow the transmission of the location information via a network to a trusted destination;
a setting to allow the location information to be accessed by user level machine accessible instructions;
a setting to allow the utilization of the location information to configure operating system level machine accessible instructions; and
a setting to allow the utilization of the location information to configure user level machine accessible instructions.

29. The system of claim 26 wherein the setting to block the accuracy of the location information includes at least one of the following:
a setting to block the utilization of the location information externally to the system;
a setting to return an alternative location information in response to a request for the location information;
a setting to request confirmation before the location information is transmitted via a network;
a setting to request confirmation before the location information is accessed by a set of machine accessible instructions; and
a setting to block the utilization of the location information by a specified set of machine accessible instructions.

30. The system of claim 24 wherein the configuring system configures the system to facilitate the use of the location mode via at least one of the following:
the utilization of a network interface;
the formatting of data based upon localization settings;
the utilization of a digital rights management scheme; and
the ability of a set of machine accessible instructions to access the location information.

31. The system of claim 25 wherein the location information includes at least one of the following:
the determined physical location of the apparatus;
a preconfigured physical location;
an invalid value for the physical locations; and
an altered version of the determined physical location of the apparatus.

32. The system of claim 25 wherein the location mode selector includes a control element that is associated with a set of machine accessible instructions that comprises at least one of the following:
a web browser;
an email client;
a map generation application;
a conferencing application; and
a specialized application used by a sales agent.

33. A method comprising:
determining the physical location of a device;
selecting a location mode from a plurality of location modes;
configuring a device based upon the location mode.

34. The method of claim 33, wherein the location mode includes
a location information and
an set of rules involving the utilization of the location information.

35. The method of claim 34, wherein the set of rules involving the utilization of the location information includes at least one set of rules from the following:
altering the location information prior to utilization;
allowing utilization of the location information under specific circumstances; and
blocking utilization of the location information.

36. The method of claim 35, wherein altering the location information prior to utilization includes at least one of the following:
reducing the accuracy of the location information by an order of magnitude;
setting the location information to an alternate value;
enhancing the location information utilizing a set of preconfigured information; and
reducing the accuracy of the location information under specific circumstances.

37. The method of claim 35, wherein allowing utilization of the location information under specific circumstances includes at least one of the following:
disallowing the utilization of the location information externally to the device;
disallowing the transmission of the location information via a network;
allowing the transmission of the location information via a network to a trusted destination;
allowing the location information to be accessed by user level machine accessible instructions;
allowing the utilization of the location information to configure operating system level machine accessible instructions; and
allowing the utilization of the location information to configure user level machine accessible instructions.

38. The method of claim 35, wherein blocking utilization of the location information includes at least one of the following:
blocking the utilization of the location information externally to the device;
returning an alternate location information in response to a request for the location information;
requesting user confirmation before the location information is transmitted via a network;
requesting user confirmation before the location information is accessed by a set of machine accessible instructions; and
blocking the utilization of the location information by a specified set of machine accessible instructions.

39. The method of claim 35, wherein configuring the device based upon the location mode includes at least one of the following:
configuring the utilization of a network interface;
configuring a localization setting;
configuring the utilization of a digital rights management scheme; and
configuring the device to dynamically provide the location information when requested by a third plurality of machine accessible instructions.

40. The method of claim 39, wherein selecting a location mode including activating a control element.

41. The method of claim 40, wherein the control element is a physical switch coupled with the device.

42. The method of claim 40, wherein the control element is associated with at least one of the following applications:
a web browser;
an email client;
a map generation application;
a conferencing application; and
a specialized application used by a sales agent.

43. The method of claim 34, wherein configuring the device based upon the location mode includes configuring the device such that the configuration is immediately utilized.

44. The method of claim 34, wherein the location information includes one of the following:
the determined physical location of a component;
a preconfigured physical location;
an invalid value for the physical location; and
an altered version of the determined physical location of a component.
